(19) United States
(12) Patent Application Publication
(10) Pub. No.: US 2020/0245232 A1
(43) Pub. Date: Jul. 30, 2020

(54) METHOD AND ELECTRONIC DEVICE FOR OPTIMIZING NETWORK SEARCH IN OUT OF SERVICE STATE

(71) Applicant: Wistron NeWeb Corp., Hsinchu (TW)

(72) Inventors: Chia-Lung YEH, Hsinchu (TW); Yun-Pin CHENG, Hsinchu (TW); Min-Chang CHANG, Hsinchu (TW)

(21) Appl. No.: 16/747,240

(22) Filed: Jan. 20, 2020

(30) Foreign Application Priority Data
Jan. 29, 2019 (TW) 108103244

(51) Int. Cl. H04W 48/16; H04W 48/18

(52) U.S. Cl. CPC H04W 48/16; H04W 48/18

(57) ABSTRACT

A method for optimizing a network search in an OoS state is provided. The method is used in an electronic device and includes: performing a network search operation when the electronic device enters an OoS state, wherein the network search operation includes: obtaining movement information sensed by a sensing device and a determination result indicating whether a GPS signal is received; setting a first OoS timer and a second OoS timer according to the movement information and the determination result, wherein the first OoS timer times a search interval for searching for an available network and the second OoS timer times a sleep interval; activating the first OoS timer and searching for an available network; activating the second OoS timer to time the sleep interval when the search interval expires; and the step of performing the network search operation is executed again when the sleep interval expires.

### CROSS REFERENCE TO RELATED APPLICATIONS

This application claims priority from Taiwan Patent Application No. 108103244, filed on Jan. 29, 2019, the disclosure of which is incorporated herein by reference in its entirety.

### BACKGROUND

### Technical Field

The present disclosure generally relates to a method and an electronic device for optimizing a network search. More specifically, aspects of the present disclosure relate to a method and an electronic device for optimizing a network search in an Out-of-Service (OoS) state.

### Description of the Related Art

Generally, when an electronic device (for example, a cell phone or a smartphone) is in an Out-of-Service (OoS) state, the electronic device keeps performing a network search operation until it finds and connects to an available network. As a result, the battery power of the electronic device is quickly consumed. For example, in the case of Internet of Vehicles (IOV), the electronic device enters the OoS state when a vehicle moves at a high speed. As a result, the electronic device remains in a no service state for a very long time because the search interval is too long. For another example, one may leave his or her mobile phone in the car and park the car in the basement. As a result, it causes the power required by the mobile phone to search for a network to increase dramatically. Based on the existing technique, the electronic device keeps searching for an available network at regular intervals until the battery power is exhausted.

Specifically, FIG. 1 is a networking search timing diagram of a conventional electronic device in an OoS state. Referring to FIG. 1, the abscissa represents time. When the electronic device enters the OoS state, the electronic device will search for a network during the search interval S. The period between the search intervals S is referred to as a sleep interval I, that is, when the electronic device does not find any available network, the electronic device stops searching for a network during the sleep interval I. The sleep interval is followed by another search interval, during which the electronic device performs another network search operation. When the electronic device cannot find any available networks, it repeatedly performs and stops the network search operation until an available network is found or the battery power of the electronic device is exhausted. As a result, an unpleasant user experience is brought to the user.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and an electronic device for optimizing a network search in an Out-of-Service (OoS) state to overcome the above disadvantages.

In an exemplary embodiment, a method for optimizing a network search in an Out-of-Service (OoS) state, used in an electronic device is provided in the disclosure. The method comprises: performing a network search operation when the electronic device enters an OoS state, wherein the network search operation comprises: obtaining movement information sensed by a sensing device and a determination result indicating whether a global satellite positioning system (GPS) signal is received; setting a first OoS timer and a second OoS timer according to the movement information and the determination result, wherein the first OoS timer times a search interval for searching for an available network and the second OoS timer times a sleep interval; activating the first OoS timer and searching for an available network; activating the second OoS timer to time the sleep interval when the search interval expires; and the step of performing the network search operation is executed again when the sleep interval expires.

In an exemplary embodiment, an electronic device for optimizing a network search in an Out-of-Service (OoS) state is provided in the disclosure. The electronic device comprises one or more processors and one or more computer storage media for storing one or more computer-readable instructions. The processor is configured to drive the computer storage media to execute the following tasks: performing a network search operation when the electronic device enters an OoS state, wherein the network search operation comprises: obtaining movement information sensed by a sensing device and a determination result indicating whether a global satellite positioning system (GPS) signal is received; setting a first OoS timer and a second OoS timer according to the movement information and the determination result, wherein the first OoS timer times a search interval for searching for an available network and the second OoS timer times a sleep interval; activating the first OoS timer and searching for an available network; activating the second OoS timer to time the sleep interval when the search interval expires; and the step of performing the network search operation is executed again when the sleep interval expires.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a networking search timing diagram of a conventional electronic device in an Oos state.

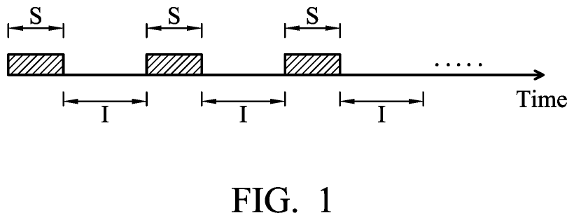

FIG. 2 illustrates an exemplary (and simplified) wireless communication system 200 according to one embodiment of the present disclosure.

FIG. 3 is a flowchart illustrating a method for optimizing a network search in an Out-of-Service (OoS) state according to an embodiment of the present disclosure.

FIG. 4 is a schematic diagram illustrating a look-up table according to an embodiment of the present disclosure.

FIG. 5 is a schematic diagram illustrating a look-up table according to an embodiment of the present disclosure.

FIG. 6 is a schematic diagram illustrating a look-up table according to an embodiment of the present disclosure.

FIGS. 7A˜7B are timing schematic diagrams illustrating a network search for an electronic device entering an Out-of-Service (OoS) state according to an embodiment of the present disclosure.

FIG. 8 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

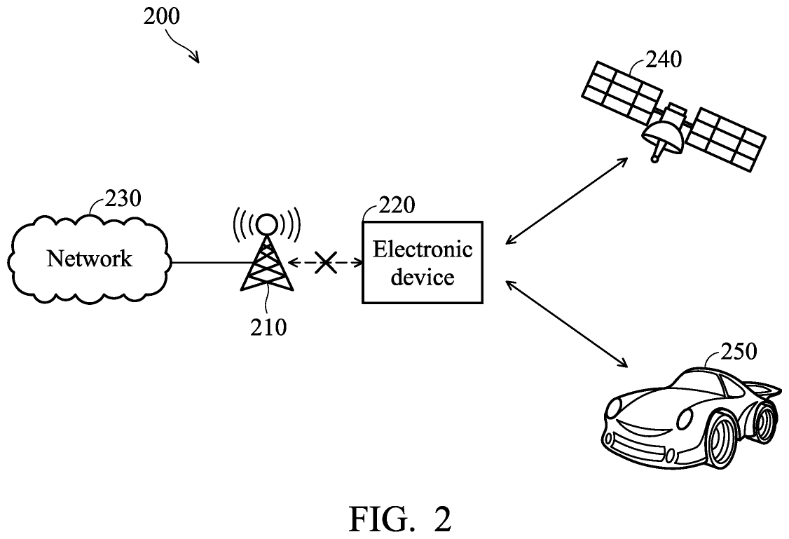

FIG. 2 illustrates an exemplary (and simplified) wireless communication system 200. It should be noted that the system of FIG. 2 is merely one example of a possible system, and embodiments of the invention may be implemented in any of various systems, as desired.

As shown in FIG. 2, the exemplary wireless communication system 200 includes a base station 210 which communicates over a transmission medium with an electronic device 220.

The base station 210 may be a base transceiver station (BTS) or cell site, and may include hardware that enables wireless communication with the electronic device 220. The base station 210 may also be equipped to communicate with a network 230 (e.g., a core network of a cellular service provider, a telecommunication network such as a public switched telephone network (PSTN), and/or the Internet, among various possibilities). Thus, the base station 210 may facilitate communication between the electronic device 220 and the network 230.

The communication area (or coverage area) of the base station may be referred to as a “cell.” The base station 210 and the electronic device 220 may be configured to communicate over the transmission medium using any of various radio access technologies (RATs), also referred to as wireless communication technologies, or telecommunication standards, such as Wireless Local Area Network (WLAN), Bluetooth, ZigBee, Worldwide Interoperability for Microwave Access (WiMAX), Third Generation Of Wireless Mobile Telecommunications Technology (3G), Fourth Generation Of Cellular Network Technology (4G), Long Term Evolution (LTE) or LTE-Advanced, etc.

It should be noted that the electronic device 220 may be capable of communicating using multiple wireless communication standards. For example, the electronic device 220 can be configured to communicate using two or more of Wireless Local Area Network (WLAN), Bluetooth, ZigBee, Worldwide Interoperability for Microwave Access (WiMAX), Third Generation Of Wireless Mobile Telecommunications Technology (3G), Fourth Generation Of Cellular Network Technology (4G), Long Term Evolution (LTE) or LTE-Advanced, one or more global navigational satellite systems (GNSS, e.g., Global Positioning System (GPS) or Assisted Global Positioning System (AGPS)), etc. Other combinations of wireless communication standards (including more than two wireless communication standards) are also possible.

Thus, the base station 210 and other similar base stations operating according to the same or a different cellular communication standard may be provided as a network of cells, which may provide continuous or nearly continuous overlapping service to the electronic devices 220 and similar devices over a wide geographic area via one or more cellular communication standards.

As shown in FIG. 2, the base station 210 can act as a serving cell for the electronic device 220. However, it is also possible that the base station 210 may lose service from its serving cell. This may occur due to movement of the electronic device 220, interference, congestion, and/or for any of a variety of other reasons (for example, the electronic device 220 is moved indoors). When no other cells are available for the electronic device 220, the electronic device 220 may enter (declare) an out-of-service (or “OoS”) state. In this case, the electronic device 220 may attempt to regain service. The manner in which the electronic device 220 is configured to attempt to regain service in the OoS state may depend on the configuration of the electronic device 220, specifications of one or more wireless communication standards according to which the electronic device 220 operates, and/or network-specified parameters, among various possibilities. As further described herein, if desired, the electronic device 220 may be configured to dynamically adapt its OoS network search operation based on movement information and GPS signals.

Specifically, since the electronic device 220 can be configured to be wirelessly connected to the GPS 240, the electronic device 220 can generate a determination result according to whether a GPS signal is received by the electronic device 220. For example, when the electronic device 220 can receive a GPS signal transmitted by the GPS 240, the electronic device 220 generates a determination result indicating that the electronic device 220 has received a GPS signal, and determines that the electronic device 220 is located in an outdoor environment according to the determination result. When the electronic device 220 cannot receive a GPS signal, the electronic device 220 generates the determination result indicating that the electronic device is not receiving a GPS signal, and determines that the electronic device 220 is located in a non-outdoor environment, such as a basement or a tunnel, according to the determination result.

When the electronic device 220 is installed in a vehicle 250, the electronic device 220 may sense movement information (for example, speed and other driving information) of the vehicle 250 through a sensing device (not shown) mounted in the vehicle 250 to determine that the electronic device 220 is stationary or in motion. In this embodiment, the sensing device is connected to a controller area network bus (CAN bus) to obtain the movement information.

The electronic device 220 may also be equipped with a sensing device for detecting motion, such as a gyroscope, an accelerometer or a G-sensor to determine whether the electronic device 220 is stationary or in motion. In another embodiment, the electronic device 220 can be utilized with other components, systems, subsystems, and/or devices than those described herein. For example, the electronic device 220 can be integrated with the sensing device as a device.

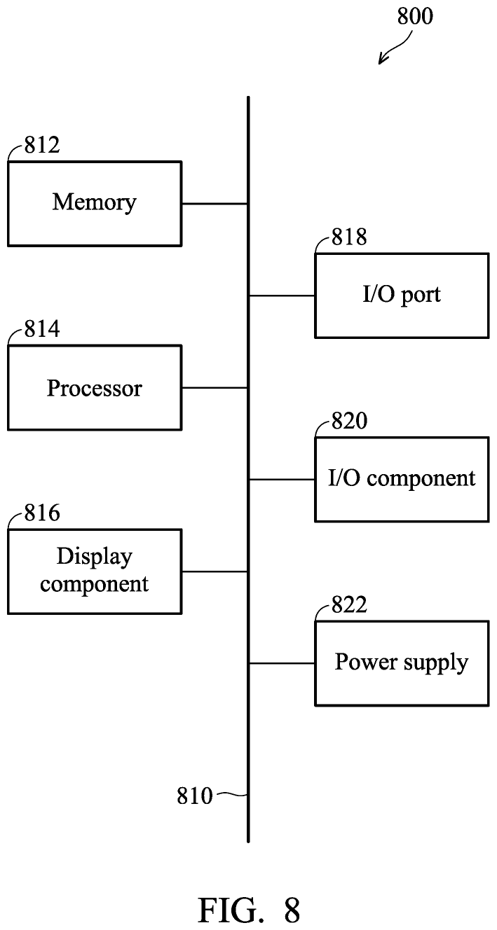

It should be understood that the electronic device 220 shown in FIG. 2 is an example of one suitable wireless communication system 200 architecture. Each of the components shown in FIG. 2 can be implemented via any type of electronic device, such as the electronic device 800 described with reference to FIG. 8, for example.

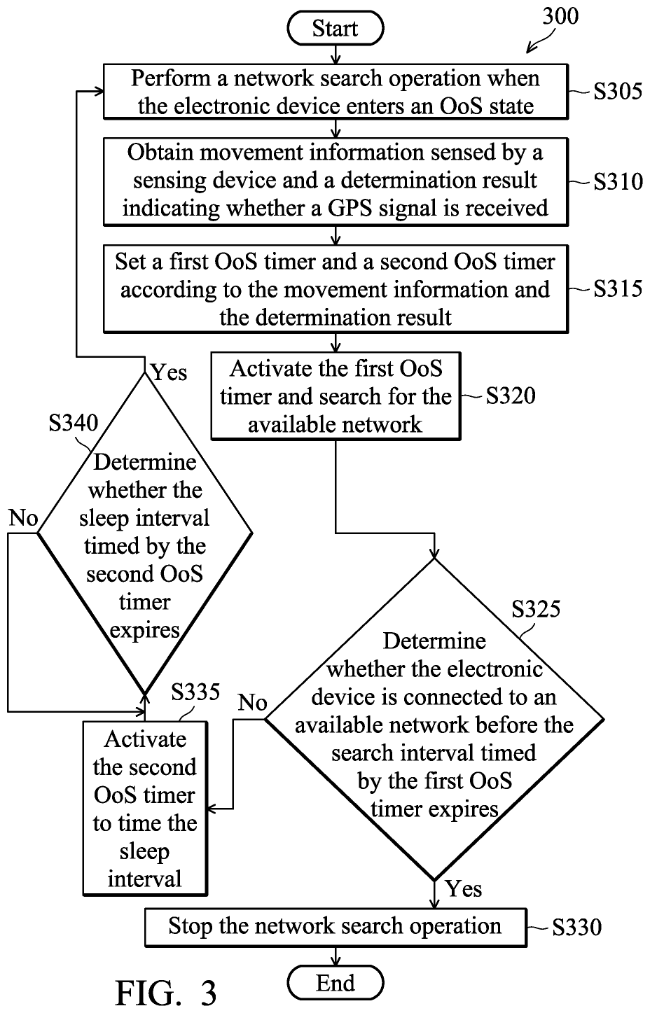

FIG. 3 is a flowchart illustrating a method 300 for optimizing a network search in an Out-of-Service (OoS) state according to an embodiment of the present disclosure. The method can be implemented in the electronic device 220 of the wireless communication system 200 as shown in FIG. 2.

When the electronic device enters an OoS state, in step S305, the electronic device performs a network search operation, that is, the electronic device performs a cell search to find out whether an available communication network exists. In step S310, the electronic device obtains movement information sensed by a sensing device and a determination result indicating whether a GPS signal is received. In step S315, the electronic device sets a first OoS timer and a second OoS timer according to the movement information and the determination result, wherein the first OoS timer times a search interval for searching for an available network and the second OoS timer times a sleep interval that the electronic device stops searching for an available network. In step S320, the electronic device activates the first OoS timer and searches for the available network.

In step S325, the electronic device determines whether the electronic device is connected to an available network before the search interval timed by the first OoS timer expires. When the electronic device determines that the electronic device is connected to an available network before the search interval timed by the first OoS timer expires (“Yes” in step S325), in step S330, the electronic device stops the network search operation. When the search interval timed by the first OoS timer expires and the electronic device is not connected to an available network (“No” in step 325), in step S335, the electronic device activates the second OoS timer to time the sleep interval. In step S340, the electronic device determines whether the sleep interval timed by the second OoS timer expires. When the sleep interval timed by the second OoS timer has not expired (“No” in step 340), the flow returns to step S340 and the electronic device continues to determine whether the sleep interval timed by the second OoS timer expires. When the sleep interval timed by the second OoS timer expires (“Yes” in step 340), the flow returns to step S305 and the electronic device re-executes the network search operation. In other words, when the sleep interval timed by the second OoS timer expires and the electronic device is not connected to an available network during the search interval, the electronic device performs the network search operation again. The electronic device may re-obtain the movement information and the determination result, and resets the search interval timed by the first OoS timer and the sleep interval timed by the second OoS timer.

In an embodiment, when the electronic device obtains the movement information and the determination result, the electronic device may use a look-up table to determine the search interval timed by the first OoS timer and the sleep interval timed by the second OoS timer. The look-up table can be in any form of data/storage structure and/or implemented in hardware/software forms.

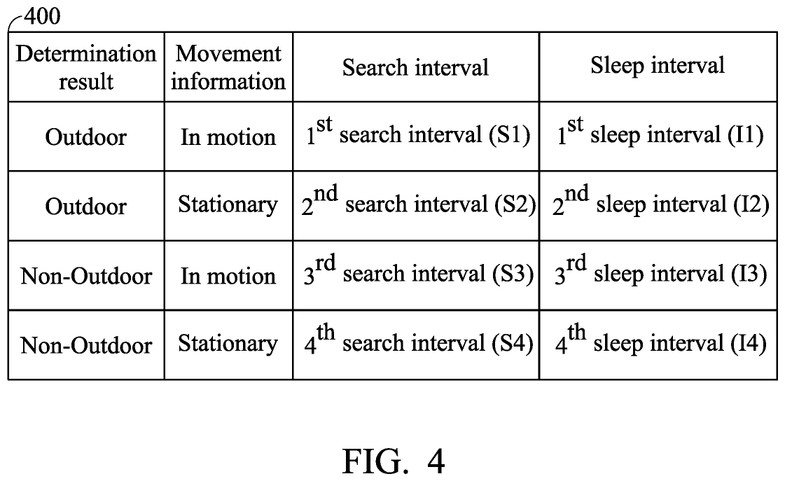

FIG. 4 is a schematic diagram illustrating a look-up table 400 according to an embodiment of the present disclosure. The look-up table 400 can be stored in a memory in the electronic device. In this embodiment, the look-up table 400 contains a list of search intervals and sleep intervals indexed by the determination results and the movement information. The determination results are expressed as “Outdoor” and “Non-Outdoor”. When the electronic device receives a GPS signal, the electronic device can determine that the electronic device is located in an outdoor environment. When the electronic device is not receiving a GPS signal, the electronic device can determine that the electronic device is not located in a non-outdoor environment. The movement information is expressed as “In motion” and “Stationary”. The electronic device can determine whether the electronic device is “in motion” or “stationary” according to the movement information sensed by the sensing device. For example, when the movement information indicates that the electronic device is “in motion” and the determination result indicates “outdoor” (i.e., the electronic device receives a GPS signal), the search interval is a first search interval (S1). When the movement information indicates that the electronic device is “stationary” and the determination result indicates “outdoor”, the search interval is a second search interval (S2). When the movement information indicates that the electronic device is “in motion” and the determination result indicates “non-outdoor” (i.e., the electronic device is not receiving a GPS signal), the search interval is a third search interval (S3). When the movement information indicates that the electronic device is “stationary” and the determination result indicates “non-outdoor”, the search interval is a fourth search interval (S4). In this embodiment, the first search interval is longer than the second search interval (S1>S2) and the third search interval (S1>S3), and the second search interval and the third search interval are longer than the fourth search interval (S2>S4) (S3>S4).

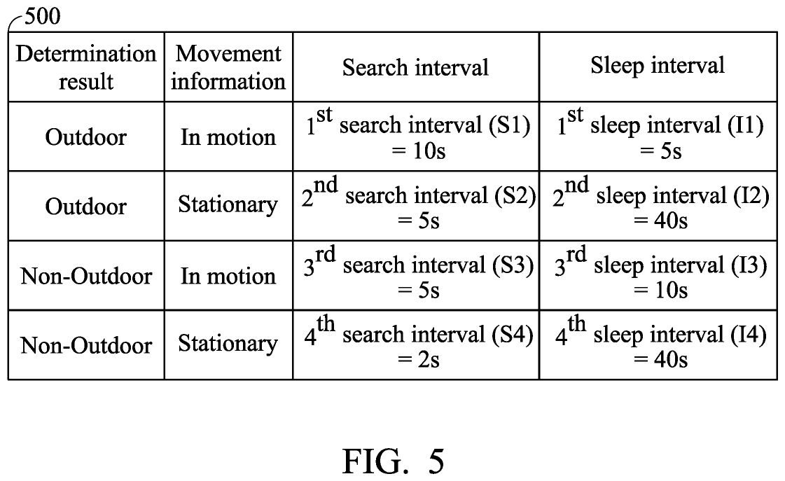

FIG. 5 is a schematic diagram illustrating a look-up table 500 according to an embodiment of the present disclosure. The look-up table 500 can be stored in a memory in the electronic device. In this embodiment, the electronic device can be installed in a vehicle device. When the movement information indicates that the electronic device is “in motion” and the determination result indicates “outdoor”, the first search interval may be preset to 10 seconds and the first sleep interval may be preset to 5 seconds. When the movement information indicates that the electronic device is “stationary” and the determination result is indicated as “outdoor”, the second search interval may be preset to 5 seconds and the second sleep interval may be preset to 40 seconds. When the movement information indicates that the electronic device is “in motion” and the determination result indicates “non-outdoor”, the third search interval may be preset to 5 seconds and the third sleep interval may be preset to 10 seconds. When the movement information indicates that the electronic device is “stationary” and the determination result indicates “non-outdoor”, the fourth search interval may be preset to 2 seconds and the fourth sleep interval may be preset to 40 seconds. It should be noted that the preset values are only an embodiment of the present disclosure, which can be set by a person skilled in the art according to actual needs. As shown in the look-up table 500, the first search interval is longer than the second search interval (S1>S2) and the third search interval (S1>S3), and the second search interval and the third search interval are longer than the fourth search interval. (S2>S4) (S3>S4). When the movement information indicates that the electronic device is “stationary”, the sleep interval has the longest period, 40 seconds, compared to the sleep interval when the electronic device is “in motion”. It should be noted that, in the look-up table 500, although the second search interval is the same as the third search interval, those skilled in the art will understand that there may be a case where the second search interval is different from the third search interval.

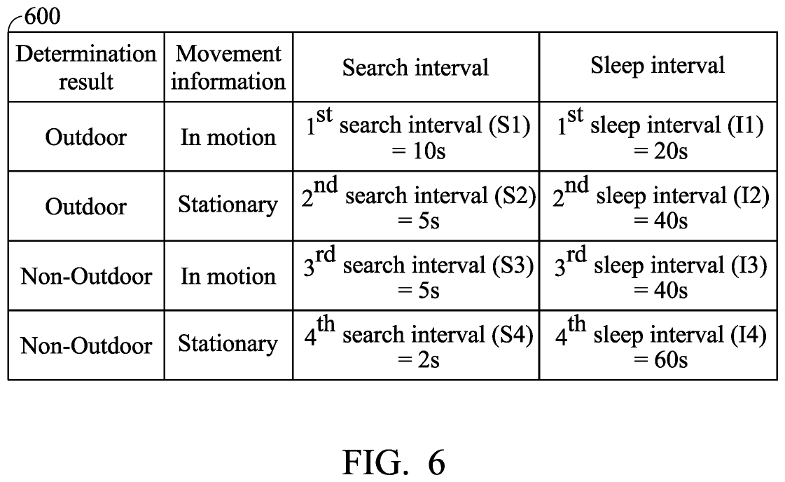

FIG. 6 is a schematic diagram illustrating a look-up table 600 according to an embodiment of the present disclosure. The look-up table 600 can be stored in a memory in the electronic device. In this embodiment, the electronic device is a mobile device equipped with a sensing device that detects motion. When the movement information indicates that the electronic device is “in motion” and the determination result indicates “outdoor”, the first search interval may be preset to 10 seconds and the first sleep interval may be preset to 20 seconds. When the movement information indicates that the electronic device is “stationary” and the determination result indicates “outdoor”, the second search interval may be preset to 5 seconds and the second sleep interval may be preset to 40 seconds. When the movement information indicates that the electronic device is “in motion” and the determination result indicates “non-outdoor”, the third search interval may be preset to 5 seconds and the third sleep interval may be preset to 40 seconds. When the movement information indicates that the electronic device is “stationary” and the determination result indicates “non-outdoor”, the fourth search interval may be preset to 2 seconds and the fourth sleep interval may be preset to 60 seconds. It should be noted that the preset values are only an embodiment of the present disclosure, which can be set by a person skilled in the art according to actual needs. As shown in the look-up table 600, the first search interval is longer than the second search interval (S1>S2) and the third search interval (S1>S3), and the second search interval and the third search interval are longer than the fourth search interval (S2>S4) (S3>S4). The first sleep interval is shorter than the second sleep interval (I1<I2) and the third sleep interval (I1<I3), and the second sleep interval and the third sleep interval are shorter than the fourth sleep interval (I2<I4) (I3<I4). It should be noted that, in the look-up table 600, although the second search interval and the second sleep interval are the same as the third search interval and the third sleep interval, those skilled in the art will understand that there may be a second search interval and a second sleep interval are different from a third search interval and a third sleep interval.

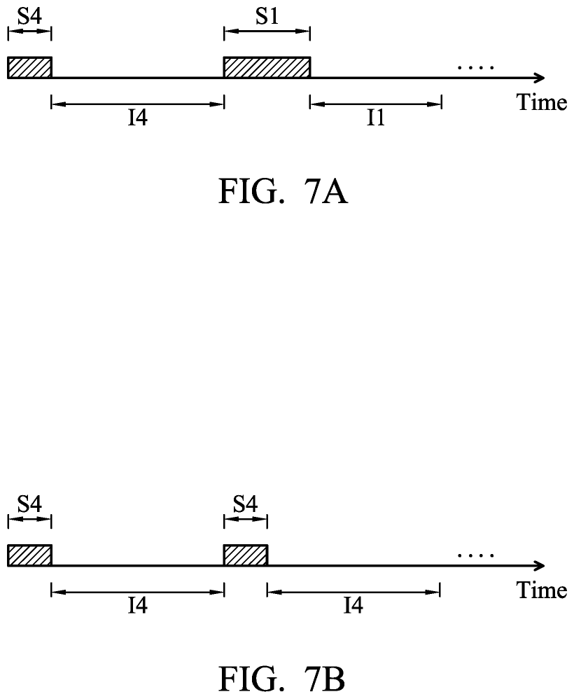

FIGS. 7A˜7B are timing schematic diagrams illustrating a network search for an electronic device entering an Out-of-Service (OoS) state according to an embodiment of the present disclosure, which refers to the look-up table 400) in FIG. 4. When the electronic device enters into an OoS state, the electronic device performs a network search operation. In FIG. 7A, it is assumed that when the movement information initially obtained by the electronic device indicates that the electronic device is “stationary” and the determination result indicates “non-outdoor”, the electronic device sets a search interval timed by a first OoS timer as the fourth search interval S4 for searching for an available network, and sets a sleep interval timed by a second OoS timer as the fourth sleep interval I4 to stop searching for an available network. After the fourth search interval S4 expires and the electronic device does not find any available network, the electronic device will enter the fourth sleep interval I4. After the fourth sleep interval I4 expires, the electronic device executes the network search operation again. In the second round of the network search operation, the electronic device re-obtains the movement information and the determination result. It is assumed that, in the second round of the network search operation, when the movement information re-obtained by the electronic device indicates that the electronic device is “in motion” and the determination result indicates “outdoor”, the electronic device sets a search interval timed by the first OoS timer as the first search interval S1 for searching for an available network, and a sleep interval timed by the second OoS timer as the first sleep interval I1 for stopping the search for an available network. The process keeps going until the electronic device finds an available network.

As another example, in FIG. 7B, when the movement information initially obtained by the electronic device indicates that the electronic device is “stationary” and the determination result indicates “non-outdoor”, the electronic device sets a search interval timed by a first OoS timer as the fourth search interval S4 for searching for an available network, and a sleep interval timed by a second OoS timer as the fourth sleep interval I4 for stopping the search for an available network. After the fourth search interval S4 expires and the electronic device does not find any available network, the electronic device will enter the fourth sleep interval I4. The fourth sleep interval I4 is followed by another fourth search interval S4. After the fourth sleep interval I4 expires, the electronic device executes the network search operation again. In the second round of the network search operation, the electronic device re-obtains the movement information and the determination result. It is assumed that, in the second round of the network search operation, the electronic device still obtains the same movement information and determination result as those in the first round of the network search operation (that is, the electronic device is still “stationary” and located in a “non-outdoor” environment), the electronic device sets a search interval timed by the first OoS timer as the fourth search interval S4 for searching for an available network, and a sleep interval timed by the second OoS timer as the fourth sleep interval I4 for stopping the search for an available network. The process keeps going until the electronic device finds an available network.

In summary, the present disclosure dynamically sets the OoS timers for searching for an available network during the search interval and stopping the search for an available network during the sleep interval according to the location where the electronic device is located. After the sleep interval expires, the network search operation can be executed again to determine whether the electronic device has moved to another location. In this way, the present disclosure can dynamically change search intervals when the electronic device searches for a network to achieve energy savings and provide users of the electronic device with a better user experience.

Having described embodiments of the present disclosure, an exemplary operating environment in which embodiments of the present disclosure may be implemented is described below. Referring to FIG. 8, an exemplary operating environment for implementing embodiments of the present disclosure is shown and generally known as an electronic device 800. The electronic device 800 is merely an example of a suitable computing environment and is not intended to limit the scope of use or functionality of the disclosure. Neither should the electronic device 800 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs. objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 8, the electronic device 800 may include a bus 810 that is directly or indirectly coupled to the following devices: one or more memories 812, one or more processors 814, one or more display components 816, one or more input/output (I/O) ports 818, one or more input/output components 820, and an illustrative power supply 822. The bus 810 may represent one or more kinds of busses (such as an address bus, data bus, or any combination thereof). Although the various blocks of FIG. 8 are shown with lines for the sake of clarity, and in reality, the boundaries of the various components are not specific. For example, the display component such as a display device may be considered an I/O component and the processor may include a memory.

The electronic device 800 typically includes a variety of computer-readable media. The computer-readable media can be any available media that can be accessed by electronic device 800 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 800. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 812 may include computer-storage media in the form of volatile and/or nonvolatile memory. The memory may be removable, non-removable, or a combination thereof. Exemplary hardware devices include solid-state memory, hard drives, optical-disc drives, etc. The electronic device 800 includes one or more processors that read data from various entities such as the memory 812 or the I/O components 820. The display component(s) 816 present data indications to a user or other device. Exemplary presentation components include a display device, speaker, printing component, vibrating component, etc.

The I/O ports 818 allow the electronic device 800 to be logically coupled to other devices including the I/O components 820, some of which may be embedded. Illustrative components include a microphone, joystick, game pad, satellite dish, scanner, printer, wireless device, etc. The I/O components 820 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 800, or any combination thereof. The electronic device 800 may be equipped with depth cameras, such as stereoscopic camera systems, infrared camera systems, RGB camera systems, or any combination thereof, to realize gesture detection and recognition. Furthermore, the electronic device 800 may be equipped with accelerometers, G-sensor or gyroscopes that enable detection of motion. The output of the accelerometers, G-sensor or gyroscopes may be provided to the display of the electronic device 800 to carry out immersive augmented reality or virtual reality.

Furthermore, the processor 814 in the electronic device 800 can execute the program code in the memory 812 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for optimizing a network search in an Out-of-Service (OoS) state, used in an electronic device, comprising:
performing a network search operation when the electronic device enters an OoS state, wherein the network search operation comprises:
obtaining movement information sensed by a sensing device and a determination result indicating whether a global satellite positioning system (GPS) signal is received;
setting a first OoS timer and a second OoS timer according to the movement information and the determination result, wherein the first OoS timer counts a search interval for searching for an available network and the second OoS timer counts a sleep interval;
activating the first OoS timer and searching for an available network;
activating the second OoS timer to time the sleep interval when the search interval expires; and
the step of performing the network search operation is executed again when the sleep interval expires.

2. The method for optimizing a network search in an Out-of-Service (OoS) state as claimed in claim 1, wherein the network search operation further comprises:
determining whether the electronic device is connected to an available network before the search interval timed by the first OoS timer expires; and
stopping the network search operation when the electronic device is connected to an available network.

3. The method for optimizing a network search in an Out-of-Service (OoS) state as claimed in claim 1, wherein the search interval and the sleep interval are obtained from a look-up table.

4. The method for optimizing a network search in an Out-of-Service (OoS) state as claimed in claim 1, wherein when the movement information indicates that the electronic device is in motion and the determination result indicates that the electronic device has received a GPS signal, the search interval is a first search interval.

5. The method for optimizing a network search in an Out-of-Service (OoS) state as claimed in claim 4, wherein when the movement information indicates that the electronic device is stationary and the determination result indicates that the electronic device has received a GPS signal, the search interval is a second search interval; or when the movement information indicates that the electronic device is in motion and the determination result indicates that the electronic device is not receiving a GPS signal, the search interval is a third search interval, wherein the first search interval is longer than the second search interval and the third search interval.

6. The method for optimizing a network search in an Out-of-Service (OoS) state as claimed in claim 5, wherein when the movement information indicates that the electronic device is stationary and the determination result indicates that the electronic device is not receiving a GPS signal, the search interval is a fourth search interval, wherein the second search interval and the third search interval are longer than the fourth search interval.

7. The method for optimizing a network search in an Out-of-Service (OoS) state as claimed in claim 5, wherein the second search interval is equal to the third search interval.

8. The method for optimizing a network search in an Out-of-Service (OoS) state as claimed in claim 1, wherein the sensing device is a gyroscope, an accelerometer, or a gravity sensor (G-sensor).

9. The method for optimizing a network search in an Out-of-Service (OoS) state as claimed in claim 1, wherein the sensing device is connected to a controller area network bus (CAN bus) installed on a vehicle to obtain the movement information.

10. The method for optimizing a network search in an Out-of-Service (OoS) state as claimed in claim 1, wherein the sensing device is integrated with the electronic device as a device.

11. An electronic device for optimizing a network search in an Out-of-Service (OoS) state, comprising:
one or more processors; and
one or more computer storage media for storing one or more computer-readable instructions, wherein the processor is configured to drive the computer storage media to execute the following tasks;
performing a network search operation when the electronic device enters an OoS state, wherein the network search operation comprises:
obtaining movement information sensed by a sensing device and a determination result indicating whether a global satellite positioning system (GPS) signal is received;
setting a first OoS timer and a second OoS timer according to the movement information and the determination result, wherein the first OoS timer times a search interval for searching for an available network and the second OoS timer times a sleep interval;
activating the first OoS timer and searching for an available network;
activating the second OoS timer to time the sleep interval when the search interval expires; and
the step of performing the network search operation is executed again when the sleep interval expires.

12. The electronic device for optimizing a network search in an Out-of-Service (OoS) state as claimed in claim 11, wherein the network search operation further comprises:
determining whether the electronic device is connected to an available network before the search interval timed by the first OoS timer expires; and
stopping the network search operation when the electronic device is connected to an available network.

13. The electronic device for optimizing a network search in an Out-of-Service (OoS) state as claimed in claim 11, wherein the search interval and the sleep interval are obtained from a look-up table.

14. The electronic device for optimizing a network search in an Out-of-Service (OoS) state as claimed in claim 11, wherein when the movement information indicates that the electronic device is in motion and the determination result indicates that the electronic device has received a GPS signal, the search interval is a first search interval.

15. The electronic device for optimizing a network search in an Out-of-Service (OoS) state as claimed in claim 14, wherein when the movement information indicates that the electronic device is stationary and the determination result indicates that the electronic device has received a GPS signal, the search interval is a second search interval; or when the movement information indicates that the electronic device is in motion and the determination result indicates that the electronic device is not receiving a GPS signal, the search interval is a third search interval, wherein the first search interval is longer than the second search interval and the third search interval.

16. The electronic device for optimizing a network search in an Out-of-Service (OoS) state as claimed in claim 15, wherein when the movement information indicates that the electronic device is stationary and the determination result indicates that the electronic device is not receiving a GPS signal, the search interval is a fourth search interval, wherein the second search interval and the third search interval are longer than the fourth search interval.

17. The electronic device for optimizing a network search in an Out-of-Service (OoS) state as claimed in claim 15, wherein the second search interval is equal to the third search interval.

18. The electronic device for optimizing a network search in an Out-of-Service (OoS) state as claimed in claim 11, wherein the sensing device is a gyroscope, an accelerometer, or a gravity sensor (G-sensor).

19. The electronic device for optimizing a network search in an Out-of-Service (OoS) state as claimed in claim 11, wherein the sensing device is connected to a controller area network bus (CAN bus) installed on a vehicle to obtain the movement information.

20. The electronic device for optimizing a network search in an Out-of-Service (OoS) state as claimed in claim 11, wherein the sensing device is integrated with the electronic device as a device.
